(19) United States
(12) Patent Application Publication
(10) Pub. No.: US 2025/0141210 A1
(43) Pub. Date: May 1, 2025

(54) System and Method for Maintaining Working Temperature of Circuit Breakers

(71) Applicant: Caterpillar Inc., Peoria, IL (US)

(72) Inventors: Firoz AHAMED, Puttur (IN); Prajod K, Kerala (IN); Sangsuk LEE, McDonough, GA (US)

(73) Assignee: Caterpillar Inc., Peoria, IL (US)

(21) Appl. No.: 18/927,250

(22) Filed: Oct. 25, 2024

(30) Foreign Application Priority Data
Oct. 27, 2023 (IN) 202311073451

(51) Int. Cl. H02H 5/04

(52) U.S. Cl. CPC H02H 5/041

(57) ABSTRACT

A system for maintaining a working temperature of a circuit breaker in an electrical system. The system includes a heater pad configured to be attached to the circuit breaker for transferring heat to a surface of the circuit breaker and a temperature sensor configured to detect a surface temperature of the circuit breaker. The system further includes a controller configured to receive data associated with the surface temperature of the circuit breaker and control transmission of power to the heater pad based on a deviation of the surface temperature to an outside of a threshold temperature range to maintain the working temperature of the circuit breaker.

### TECHNICAL FIELD

The present disclosure relates to a system and a method for maintaining working temperature of circuit breakers in an electrical system.

### BACKGROUND

Thermally actuated circuit breakers are commonly used in many electrical circuits to protect, control, and isolate electrical equipment during an overcurrent condition. Circuit breakers may be designed and built to operate between a temperature range of minus (−) 25 degree Celsius and plus (+) 70 degree Celsius. However, some circuit breakers operate in territories that are generally subject to temperatures below the minimum operating temperature range of the circuit breakers, e.g., below minus (−) 25 degree Celsius. This may lead to a delayed trip during the overcurrent condition and cause failure of downstream components, such as, cables/wires/electrical components connected to the circuit breakers.

Chinese Utility Model No. 216773150 relates to a heat preservation device for a circuit breaker. The heat preservation device for the circuit breaker comprises a power supply unit, a temperature control unit and a heating unit. The power supply unit is electrically connected with the temperature control unit through a wire, and the temperature control unit is electrically connected with the heating unit through a wire. The heating unit comprises a heating sheet, and a fixing unit is arranged on the heating sheet. When in use, the heating unit is fixed on the outer wall of the circuit breaker box body through the fixing unit. The fixing unit is a high-temperature double-faced adhesive tape or magnet adsorption mechanism. The heat preservation device for the circuit breaker solves the heat preservation problem of a circuit breaker device based on green energy.

### SUMMARY OF THE INVENTION

In one aspect, the disclosure relates to a system for maintaining a working temperature of a circuit breaker in an electrical system. The system includes a heater pad configured to be attached to the circuit breaker for transferring heat to a surface of the circuit breaker and a temperature sensor configured to detect a surface temperature of the circuit breaker. The system further includes a controller configured to receive data associated with the surface temperature of the circuit breaker and control transmission of power to the heater pad based on a deviation of the surface temperature to an outside of a threshold temperature range to maintain the working temperature of the circuit breaker.

In another aspect, the disclosure is directed to a method for maintaining a working temperature of a circuit breaker in an electrical system. The method includes attaching a heater pad to the circuit breaker to transfer heat to a surface of the circuit breaker and detecting, by a temperature sensor, a surface temperature of the circuit breaker. The method further includes receiving, by a controller, data associated with the surface temperature of the circuit breaker and controlling, by the controller, transmission of power to the heater pad based on a deviation of the surface temperature to an outside of a threshold temperature range to maintain the working temperature of the circuit breaker.

In yet another aspect, the disclosure relates to an electrical system. The electrical system includes a power supply source, one or more electrical components configured to receive power from the power supply source, and a switchgear including a circuit breaker to isolate the one or more electrical components during an overcurrent condition. The electrical system further includes a system for maintaining a working temperature of the circuit breaker. The system includes a heater pad configured to be attached to the circuit breaker for transferring heat to a surface of the circuit breaker and a temperature sensor configured to detect a surface temperature of the circuit breaker. The system further includes a controller configured to receive data associated with the surface temperature of the circuit breaker and control transmission of power to the heater pad based on a deviation of the surface temperature to an outside of a threshold temperature range to maintain the working temperature of the circuit breaker.

### BRIEF DESCRIPTION OF THE DRAWINGS

FIG. 1 is a schematic view of a system for maintaining a working temperature of a circuit breaker in an electrical system, in accordance with one or more aspects of the present disclosure; and

FIG. 2 is a flowchart illustrating a method for maintaining the working temperature of the circuit breaker in the electrical system, in accordance with one or more aspects of the present disclosure.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts. Generally, corresponding reference numbers may be used throughout the drawings to refer to the same or corresponding parts, e.g., 1, 1′, and 1″ could refer to one or more comparable components used in the same and/or different depicted embodiments.

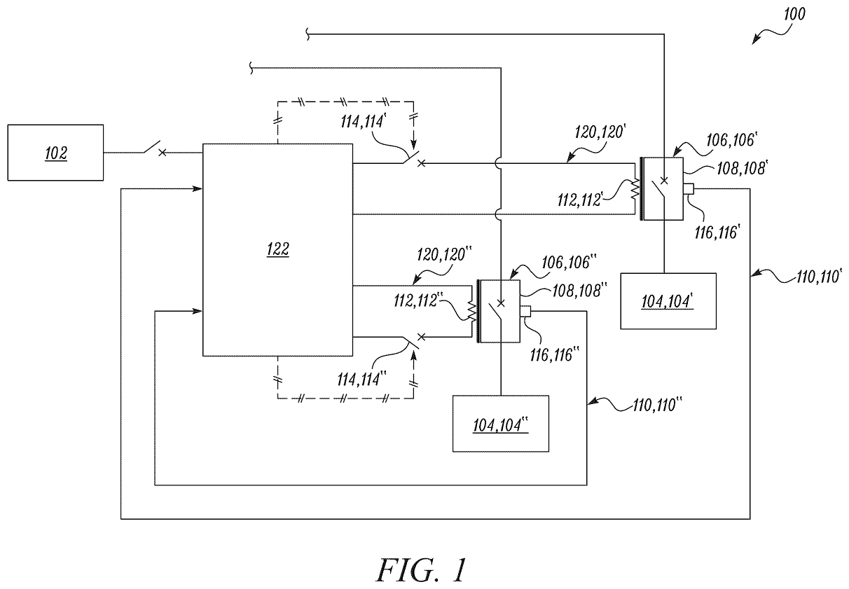

Referring to FIG. 1, an exemplary electrical system 100 is shown and described. The electrical system 100 may be employed in commercial or residential settings for powering one or more electrical loads. In some embodiments, the electrical system 100 may be employed in a machine (e.g., a work machine, such as an excavator, a loader, and/or the like) to power one or more electrical components and/or a mobility of the machine. The electrical system 100 includes a power supply source 102. The power supply source 102 may supply electrical power to the one or more electrical loads and/or the one or more electrical components. The power supply source 102 can be a mains power supply source provided by electric power companies and/or electric utilities, a shore power supply source provided by a shore-based power source, for example, a power plant and/or a renewable energy source, an energy storage device, such as a battery or a fuel cell, or a generator.

The electrical system 100 further includes one or more electrical circuits 110, for example, a first electrical circuit 110′ and a second electrical circuit 110″. The first electrical circuit 110′ includes one or more electrical components 104, for example, a first electrical component 104′. The first electrical component 104′ may include components or devices or portions of the electrical system 100 that may consume electrical power. For example, the first electrical component 104′ may include a heating, ventilation, and air conditioning (HVAC) system, lighting, displays, and the like devices. The first electrical component 104′ may be configured to receive the electrical power from the power supply source 102. In some embodiments, the first electrical component 104′ may be configured to receive the electrical power from a power supply source (not shown) other than the power supply source 102.

In accordance with various embodiments, the first electrical component 104′ is connected to the power supply source, via one or more switchgears 106, for example, but not limited to, a first switchgear 106′. The first switchgear 106′ may include one or more circuit breakers 108, for example, a first circuit breaker 108′. The first electrical component 104′ is connected to its power supply source, for example, the power supply source 102, via the first circuit breaker 108′. The first circuit breaker 108′ is configured to isolate the corresponding first electrical component 104′ from the power supply source. The isolation may be performed by interrupting the supply of electrical power from the power supply source to the first electrical component 104′. For example, the first circuit breaker 108′ may include one or more of a shore power circuit breaker and a main circuit breaker. When the first circuit breaker 108′ is a shore power circuit breaker, the first circuit breaker 108′ may isolate the corresponding first electrical component 104′ from the power supply source (such as, the shore power supply source) when a fault occurs with the shore power supply source. When the first circuit breaker 108′ is a main circuit breaker, the first circuit breaker 108′ may isolate the corresponding first electrical component 104′ from the power supply source during a fault condition, e.g., overcurrent or a short circuit condition in the electrical system 100. The first switchgear 106′ may include one or more other components, such as a relay, a transformer, and/or any other device, adapted to provide selective coupling between the first electrical component 104′ and the power supply source.

In accordance with various embodiments, the first circuit breaker 108′ has an optimal operating temperature range. The optimal temperature range may correspond to the temperature range in which the first circuit breaker 108′ is designed to operate effectively. For example, an optimal temperature range for the first circuit breaker 108′ may be between a temperature range of minus (−) 25 degrees Celsius and plus (+) 70 degree Celsius. In an embodiment, the optimal temperature range may depend on various parameters, such as, an application and/or a type of the first circuit breaker 108′ and may be different for different circuit breakers 108. For example, in some cases, the optimal temperature range for a shore power circuit breaker may be different from the optimal temperature range for a main power circuit breaker. The above values provided for the optimal temperature range have been provided for illustrative purposes.

The first electrical circuit 110′ further includes a system 120, for example, a first system 120′, for maintaining a working temperature of the first circuit breaker 108′. To this end, the first system 120′ includes one or more heater pads 112, for example, a first heater pad 112′ configured to be attached to the first circuit breaker 108′ for transferring heat to a surface of the first circuit breaker 108′. In accordance with various embodiments, the first heater pad 112′ can include any heater pad that can be controlled to transfer the heat to the surface of the first circuit breaker 108′. For example, the first heater pad 112′ is an electrical heating pad, such as, but not limited to a wire-wound silicone rubber heater pad that may conductively transfer the heat to the surface of the first circuit breaker 108′.

In accordance with various embodiments, the first heater pad 112′ is configured to receive the electrical power from the power supply source 102 and convert the electrical power into heat energy. The heat energy is then transferred to the surface of the first circuit breaker 108′. In accordance with various embodiments, the configuration of the first heater pad 112′ depends on the application or type of the first circuit breaker 108′. For example, when the first circuit breaker 108′ is a main circuit breaker, the first heater pad 112′ may correspond to a 225 watts (W) heater pad and when the first circuit breaker 108′ is a shore power circuit breaker, the first heater pad 112′ may correspond to a 50 watts (W) heater pad. In some embodiments, the configuration of the first heater pad 112′ also depends on an ambient temperature condition of the first circuit breaker 108′.

The first system 120′ further includes one or more switches 114, for example, a first switch 114′ operatively coupled between the power supply source 102 and the first heater pad 112′ to control supply of the electrical power from the power supply source 102 to the first heater pad 112′. In accordance with various embodiments, the electrical power from the power supply source 102 is supplied to the first heater pad 112′ when the first switch 114′ is in a Normally Closed (NC) state and the supply of the electrical power is disconnected when the first switch 114′ is in a Normally Open (NO) state.

The first system 120′ further includes one or more temperature sensors 116, for example, a first temperature sensor 116′, configured to detect a surface temperature of the first circuit breaker 108′. The first temperature sensor 116′ may be coupled to the first circuit breaker 108′, for example, by installing the first temperature sensor 116′ on the surface of the first circuit breaker 108′ by a suitable method, e.g., by use of industrial adhesives, and the like, and which may be contemplatable by someone of skill in the art. The first temperature sensor 116′ can be any known temperature sensor, for example, a thermocouple, configured to detect the surface temperature of the first circuit breaker 108′.

The first system 120′ further includes a controller 122 configured to receive data associated with the surface temperature of the first circuit breaker 108′, for example, from the first temperature sensor 116′. The controller 122 is further configured to control transmission of the electrical power from the power supply source 102 to the first heater pad 112′ based on a deviation of the surface temperature to an outside of a threshold temperature range to maintain the working temperature of the first circuit breaker 108′.

In accordance with various embodiments, the threshold temperature range is defined by a user and falls within the optimal operating temperature range of the first circuit breaker 108′ so as to maintain the working temperature of the first circuit breaker 108.′ For example, when the optimal temperature range for the first circuit breaker 108′ is between minus (−) 25 degree Celsius and plus (+) 70 degree Celsius, the threshold temperature range may correspond to a temperature range of minus (−) 25 degree Celsius to minus (−) 20 degree Celsius. In an exemplary embodiment, the threshold temperature range may be stored in a memory (not shown), e.g., of the controller 122. In some embodiments, the threshold temperature range for different circuit breakers may be different. For example, the threshold temperature range for the shore power circuit breaker may be different from the threshold temperature range for the main circuit breaker. The above values provided for the threshold temperature range have been provided for illustrative purposes.

In order to control transmission of the electrical power from the power supply source 102 to the first heater pad 112′, the controller 122 is configured to determine, for the first circuit breaker 108′, whether the surface temperature of the first circuit breaker 108′ recedes below a lower temperature limit of the threshold temperature range. When the surface temperature of the first circuit breaker 108′ recedes below the lower temperature limit of the threshold temperature range, the controller 122 is configured to supply the electrical power from the power supply source 102 to the first heater pad 112′ such that the first heater pad 112′ transfers the heat to the surface of the first circuit breaker 108′ to raise the surface temperature above the lower temperature limit. To this end, the controller 122 is configured to supply the electrical power to the first heater pad 112′ by changing a state of the first switch 114′ from the NO state to the NC state.

For example, when the surface temperature of the first circuit breaker 108′ recedes below minus (−) 25 degree Celsius, the controller 122 supplies the electrical power from the power supply source 102 to the first heater pad 112′ by changing the state of the first switch 114′ from the NO state to the NC state such that the first heater pad 112′ transfers the heat to the surface of the first circuit breaker 108′ to raise the surface temperature above minus (−) 25 degree Celsius.

In accordance with various embodiments, the controller 122 is further configured to determine, for the first circuit breaker 108′, whether the surface temperature of the first circuit breaker 108′ rises above a higher temperature limit of the threshold temperature range. When the surface temperature of the first circuit breaker 108′ rises above the higher temperature limit of the threshold temperature range, the controller 122 is configured to disconnect supply of the electrical power from the power supply source 102 to the first heater pad 112′ when the surface temperature rises above the higher temperature limit such that the first heater pad 112′ restricts or stops transfer of the heat to the surface of the first circuit breaker 108′ to bring the surface temperature below the higher temperature limit. To this end, the controller 122 is configured to disconnect supply of the electrical power to the first heater pad 112′ by changing a state of the first switch 114′ from the NC state to the NO state.

For example, when the surface temperature of the first circuit breaker 108′ rises above minus (−) 20 degree Celsius, the controller 122 disconnects the supply of the electrical power from the power supply source 102 to the first heater pad 112′ by changing the state of the first switch 114′ from the NC state to the NO state such that the first heater pad 112′ restricts or stops transfer of the heat to the surface of the first circuit breaker 108′ to bring the surface temperature below minus (−) 20 degree Celsius.

The controller 122 may include one or more microprocessors, microcomputers, microcontrollers, programmable logic controller, DSPs (digital signal processors), central processing units, state machines, logic circuitry, or any other device or devices that process/manipulate information or signals based on operational or programming instructions. The controller 122 may be implemented using one or more controller technologies, such as Application Specific Integrated Circuit (ASIC), Reduced Instruction Set Computing (RISC) technology, Complex Instruction Set Computing (CISC) technology, etc. The memory of the controller 122 may include a random access memory (RAM) and read only memory (ROM). The RAM may be implemented by Synchronous Dynamic Random Access Memory (SDRAM), Dynamic Random Access Memory (DRAM), and/or any other type of random access memory device. The ROM may be implemented by a hard drive, flash memory and/or any other desired type of memory device.

The second electrical circuit 110″ of the electrical system 100 includes a second electrical component 104″, a second switchgear 106″ including a second circuit breaker 108″, and a second system 120″. The second system 120″ further includes a second heater pad 112″, a second temperature sensor 116″, a second switch 114″, and the controller 122. It will be appreciated that the functionality of the second electrical circuit 110″ can be understood by way of description of the first electrical circuit 110′, the details of which are not described herein for the sake of brevity.

### INDUSTRIAL APPLICABILITY

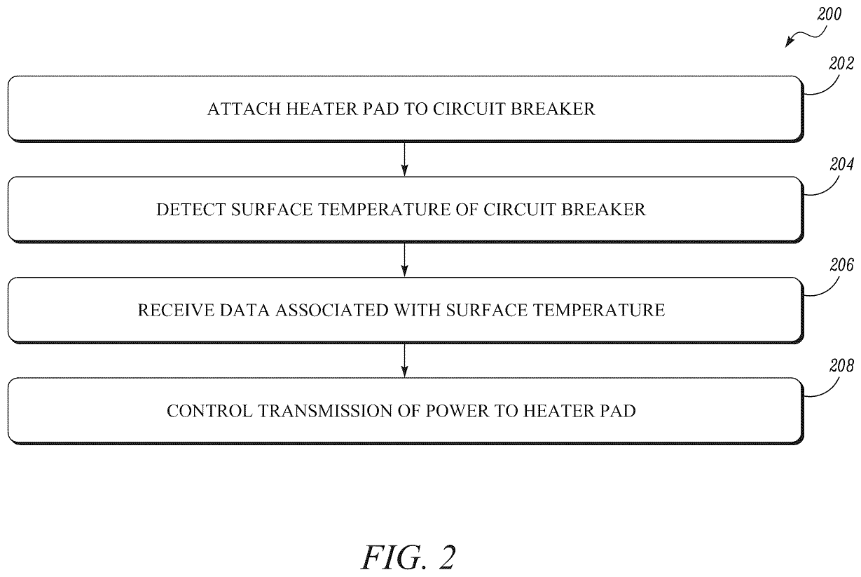

When the circuit breakers 108 are installed in territories that are generally subject to temperatures below the minimum operating temperature range of the circuit breakers 108, e.g., below minus (−) 25 degree Celsius, it is needed to maintain the working temperature of the circuit breakers 108 to avoid any delayed trip during the overcurrent or short-circuit condition. FIG. 2 describes an exemplary method 200 for maintaining the working temperature of the circuit breakers 108 in the electrical system 100. Although the method 200 is described for one circuit breaker 108, for example, the first circuit breaker 108′, it will be appreciated that the method 200 is equally applicable to other circuit breakers 108, for example, the second circuit breaker 108″, installed in the electrical system 100. The method is discussed by way of a flowchart and is discussed in conjunction with FIG. 1, as well.

The method starts at stage 202. At stage 202, the first heater pad 112′ is attached to the first circuit breaker 108′ to transfer heat to the surface of the first circuit breaker 108. At stage 204, the first temperature sensor 116′ detects the surface temperature of the first circuit breaker 108′ and provides the data corresponding to the surface temperature of the first circuit breaker 108′ to the controller 122. At stage 206, the controller 122 receives data associated with the surface temperature of the first circuit breaker 108′ and controls the transmission of power to the first heater pad 112′ based on the deviation of the surface temperature to the outside of the threshold temperature range to maintain the working temperature of the first circuit breaker 108′ at stage 208.

With the system and method of the present disclosure, the circuit breakers 108 can effectively function even in regions where ambient temperature fall outside of (e.g., below) the optimal operating temperature range of the circuit breakers 108 and thus is able to prevent delayed trip instances of the circuit breakers 108. The surface temperature of the circuit breakers 108 may be continuously or intermittently (e.g., in regular intervals) monitored by the controller 122 and the supply of the electrical power from the power supply source 102 may be continuously or intermittently (e.g., in regular intervals) adjusted to ensure that the surface temperature of the circuit breakers 108 lies within the threshold temperature range defined by the user.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

1. A system for maintaining a working temperature of a circuit breaker in an electrical system, the system comprising:
a heater pad configured to be attached to the circuit breaker for transferring heat to a surface of the circuit breaker;
a temperature sensor configured to detect a surface temperature of the circuit breaker; and
a controller configured to:
receive data associated with the surface temperature of the circuit breaker; and
control transmission of power to the heater pad based on a deviation of the surface temperature to an outside of a threshold temperature range to maintain the working temperature of the circuit breaker.

2. The system as claimed in claim 1, wherein to control transmission of power to the heater pad, the controller is configured to:
determine whether the surface temperature of the circuit breaker recedes below a lower temperature limit of the threshold temperature range or rises above a higher temperature limit of the threshold temperature range;
supply the power to the heater pad when the surface temperature recedes below the lower temperature limit such that the heater pad transfers the heat to the surface of the circuit breaker to raise the surface temperature above the lower temperature limit; and
disconnect supply of the power to the heater pad when the surface temperature rises above the higher temperature limit such that the heater pad restricts or stops transfer of the heat to the surface of the circuit breaker to bring the surface temperature below the higher temperature limit.

3. The system as claimed in claim 2, wherein the threshold temperature range corresponds to a temperature range of minus 25 degree Celsius to minus 20 degree Celsius.

4. The system as claimed in claim 1, wherein the heater pad corresponds to a 225 W heater pad when the circuit breaker is a main circuit breaker.

5. The system as claimed in claim 1, wherein the heater pad corresponds to 50 W heater pad when the circuit breaker is a shore power circuit breaker.

6. The system as claimed in claim 1, wherein the heater pad includes a silicon rubber heater pad and conductively transfers the heat to the surface of the circuit breaker.

7. The system as claimed in claim 1, wherein the threshold temperature range falls within an optimal operating temperature range of the circuit breaker.

8. The system as claimed in claim 1, wherein the temperature sensor is a thermocouple coupled to the circuit breaker.

9. A method for maintaining a working temperature of a circuit breaker in an electrical system, the method comprising:
attaching a heater pad to the circuit breaker to transfer heat to a surface of the circuit breaker;
detecting, by a temperature sensor, a surface temperature of the circuit breaker;
receiving, by a controller, data associated with the surface temperature of the circuit breaker; and
controlling, by the controller, transmission of power to the heater pad based on a deviation of the surface temperature to an outside of a threshold temperature range to maintain the working temperature of the circuit breaker.

10. The method as claimed in claim 9, wherein controlling the transmission of power to the heater pad includes:
determining, by the controller, whether the surface temperature of the circuit breaker recedes below a lower temperature limit of the threshold temperature range or rises above a higher temperature limit;
supplying, by the controller, the power to the heater pad when the surface temperature recedes below the lower temperature limit such that the heater pad transfers the heat to the surface of the circuit breaker to raise the surface temperature above the lower temperature limit; and
disconnect supply of the power to the heater pad when the surface temperature rises above the higher temperature limit such that the heater pad restricts or stops transfer of the heat to the surface of the circuit breaker to bring the surface temperature below the higher temperature limit.

11. The method as claimed in claim 10, wherein the threshold temperature range corresponds to a temperature range of minus 25 degree Celsius to minus 20 degree Celsius.

12. The method as claimed in claim 9, wherein the heater pad corresponds to a 225 W heater pad when the circuit breaker is a main circuit breaker.

13. The method as claimed in claim 9, wherein the heater pad corresponds to 50 W heater pad when the circuit breaker is a shore power circuit breaker.

14. The method as claimed in claim 9, wherein the heater pad includes a silicon rubber heater pad and conductively transfers the heat to the surface of the circuit breaker.

15. The method as claimed in claim 9, wherein the threshold temperature range falls within an optimal operating temperature range of the circuit breaker.

16. The method as claimed in claim 9, wherein the temperature sensor is a thermocouple coupled to the circuit breaker.

17. An electrical system comprising:
a power supply source;
one or more electrical components configured to receive power from the power supply source;
a switchgear including a circuit breaker to isolate the one or more electrical components during an overcurrent condition; and
a system for maintaining a working temperature of the circuit breaker, the system including:
a heater pad configured to be attached to the circuit breaker for transferring heat to a surface of the circuit breaker;
a temperature sensor configured to detect a surface temperature of the circuit breaker; and
a controller configured to:
receive data associated with the surface temperature of the circuit breaker; and
control transmission of power to the heater pad based on a deviation of the surface temperature to an outside of a threshold temperature range to maintain the working temperature of the circuit breaker.

18. The electrical system as claimed in claim 17, wherein to control transmission of power to the heater pad, the controller is configured to:
determine whether the surface temperature of the circuit breaker recedes below a lower temperature limit of the threshold temperature range or rises above a higher temperature limit of the threshold temperature range;
supply the power to the heater pad when the surface temperature recedes below the lower temperature limit such that the heater pad transfers the heat to the surface of the circuit breaker to raise the surface temperature above the lower temperature limit; and
disconnect supply of the power to the heater pad when the surface temperature rises above the higher temperature limit such that the heater pad restricts or stops transfer of the heat to the surface of the circuit breaker to bring the surface temperature below the higher temperature limit.

19. The electrical system as claimed in claim 18, the threshold temperature range corresponds to a temperature range of minus 25 degree Celsius to minus 20 degree Celsius.

20. The electrical system as claimed in claim 17, wherein the threshold temperature range falls within an optimal operating temperature range of the circuit breaker.
